(19) United States
(12) Patent Application Publication
(10) Pub. No.: US 2025/0104918 A1
(43) Pub. Date: Mar. 27, 2025

(54) MULTILAYERED CERAMIC CAPACITOR AND METHOD FOR MANUFACTURING SAME

(71) Applicant: AMOTECH CO., LTD., Incheon (KR)

(72) Inventors: Byungguk LIM, Incheon (KR); Jaeyong SONG, Incheon (KR); Yunsuk CHOI, Incheon (KR)

(73) Assignee: AMOTECH CO., LTD., Incheon (KR)

(21) Appl. No.: 18/725,788

(22) PCT Filed: Dec. 7, 2022
(86) PCT No.: PCT/KR2022/019763

§ 371 Date: Jun. 30, 2024

(30) Foreign Application Priority Data
Dec. 30, 2021 (KR) 10-2021-0191917

(51) Int. Cl. H01G 4/228; H01G 4/30

(52) U.S. Cl. CPC H01G 4/228; H01G 4/30

(57) ABSTRACT

Disclosed is a multilayer ceramic capacitor. The present invention comprises: a ceramic body in which a plurality of dielectric layers are stacked; a recessed portion which is recessedly formed at a corner where a side surface of the ceramic body and a bottom surface of the ceramic body contact each other; and a lower electrode formed on the bottom surface of the ceramic body.

### TECHNICAL FIELD

The present disclosure relates to a multilayer ceramic capacitor and a method for manufacturing the same, and more particularly, to a multilayer ceramic capacitor and a method for manufacturing the same, in which a depression area is provided on a side surface of the capacitor and thus a joining force between a circuit board and a lower electrode is reinforced.

### BACKGROUND ART

Recently, with the development of IT technology, the demand for multilayer ceramic capacitors (MLCC) is increasing significantly.

A multilayer ceramic capacitor is a component which makes a semiconductor operate smoothly by storing electricity and by stably supplying the electricity as much as an active component, such as the semiconductor, needs. Since the multilayer ceramic capacitor prevents the component, such as the semiconductor, from being broken by constantly supplying current, it is mounted on most products provided with electronic circuits.

Although the multilayer ceramic capacitor has the smallest size among electronic components, 500 to 700 layers of dielectrics and electrodes overlap one another in the multilayer ceramic capacitor, and the more the dielectrics are stacked, the more electricity can be stored. Accordingly, stacking of a lot of dielectrics in a small space is the core technology in a method for manufacturing the multilayer ceramic capacitor.

Meanwhile, the multilayer ceramic capacitor is composed of dielectrics, inner electrodes, and outer electrodes, and electric charge is accumulated between the inner electrodes facing each other. However, in case of high frequencies requiring a quick response, a low-capacity multilayer ceramic capacitor having a small number of laminations of inner electrodes or having no inner electrode is used.

In this case, if the number of laminations of inner electrodes is small, a tensile strength is weak, and thus cracks may easily occur in a soldering process.

If the cracks occur in the multilayer ceramic capacitor that requires a high level of durability, there is a problem in that the performance of the multilayer ceramic capacitor is decreased.

The matters described in the above background technology are to help understanding of the background of the present disclosure, and may include the matters that are not the disclosed related art.

### SUMMARY OF INVENTION

### Technical Problem

An object of the present disclosure is to provide a multilayer ceramic capacitor and a method for manufacturing the multilayer ceramic capacitor, in which cracks are prevented from occurring in a soldering process, and joining between a dielectric and a lower electrode is stably maintained after the soldering.

Technical matters to be solved by the present disclosure are not limited to the above-mentioned technical matters, and other unmentioned technical matters will be able to be clearly understood by those of ordinary skill in the art from the following description.

### Solution to Problem

In order to solve the above technical matters, a multilayer ceramic capacitor according to an embodiment of the present disclosure includes: a ceramic body in which a plurality of dielectric layers are laminated; a recessed part formed to be depressed at a corner where a side surface of the ceramic body and a lower surface of the ceramic body come in contact with each other; and a lower electrode formed on the lower surface of the ceramic body.

Further, the recessed part may be formed to be depressed so that one side surface thereof is open.

Further, the recessed part may be formed to be depressed so that a lower surface and one side surface thereof are open.

Further, the recessed part may be provided with a continuous curved surface that is formed to be depressed.

Further, the lower electrode may be formed in a shape that opens the lower surface of the recessed part.

Further, the lower electrode may be formed to be depressed at a location that corresponds to the lower surface of the recessed part.

Further, the ceramic body may include an inner electrode disposed inside the ceramic body, and the inner electrode may include a first inner electrode spaced apart from the side surface of the ceramic body and having both ends that overlap the lower electrode.

Further, the inner electrode may include a second inner electrode disposed to be spaced apart from the first inner electrode and exposed to the recessed part.

Further, the ceramic body may include a dummy electrode disposed inside the ceramic body and exposed to both side surfaces of the ceramic body.

Further, the dummy electrode may be disposed inside the ceramic body and exposed through an upper surface of the recessed part.

Further, the recessed part includes a metal layer formed on a surface of the recessed part and electrically connected to the lower electrode.

Further, in order to solve the above technical matters, a method for manufacturing a multilayer ceramic capacitor according to an embodiment of the present disclosure includes: a step of preparing a first dielectric layer having a plurality of through-holes; a step of forming a ceramic laminate by laminating a second dielectric layer and a third dielectric layer on an upper part of the first dielectric layer; and a cutting step of forming a plurality of unit ceramic bodies by cutting the ceramic laminate so that the through-hole is separated into different unit ceramic bodies.

Further, in the cutting step, the through-hole may be separated into the different ceramic bodies, and a recessed part may be formed on each of the unit ceramic bodies.

Further, in the step of forming the ceramic laminate, the second dielectric layer may be provided with a dummy electrode.

Further, in the step of forming the ceramic laminate, the third dielectric layer may be provided with an inner electrode.

Further, the step of forming the ceramic laminate includes a step of forming a metal layer on the through-hole.

Further, in the step of forming the through-hole, a cross section of the through-hole may be circular.

Further, the step of forming the plurality of unit ceramic bodies includes a step of forming a lower electrode on both sides of a lower surface of each of the unit ceramic bodies.

### Advantageous Effects of Invention

According to the present disclosure, the following effects can be produced.

First, since the recessed part is formed to be depressed at the corner of the ceramic body, the surface area of the side surface of the ceramic body is increased. Accordingly, in case of soldering the lower electrode on the circuit board, the amount of solder that can contact the ceramic body is increased. Due to this, the lower electrode and the ceramic body can be stably joined.

Further, in the present disclosure, since the dummy electrode that is exposed to both side surfaces of the ceramic body is provided, the tensile strength is improved.

Further, in case of soldering the lower electrode on the board, since the solder rises up from the side surface of the ceramic body to the dummy electrode, the soldering height can be increased, and thus the lower electrode can be stably mounted on the circuit board.

Effects of the present disclosure are not limited to the above-mentioned effects, and other unmentioned effects will be clearly understood by those of ordinary skill in the art from the following description.

### BRIEF DESCRIPTION OF DRAWINGS

FIG. 1 is a perspective view illustrating a state where a multilayer ceramic capacitor according to an embodiment of the present disclosure is mounted on a circuit board through soldering.

FIG. 2 is a perspective view illustrating a first embodiment of the present disclosure.

FIG. 3 is a cross-section view taken along line A-A′ of FIG. 2.

FIG. 4 is a cross-sectional view illustrating an inner electrode added to an embodiment of FIG. 2.

FIG. 5 is a cross-sectional view illustrating another embodiment of FIG. 4.

FIG. 6 is a cross-sectional view illustrating still another embodiment of FIG. 4.

FIG. 7 is a cross-sectional view illustrating a shape in which the embodiment of FIG. 5 is mounted on a circuit board through soldering.

FIG. 8 is a perspective view illustrating a second embodiment of the present disclosure.

FIG. 9 is a cross-sectional view taken along line B-B′ of FIG. 8.

FIG. 10 is a bottom view of FIG. 8.

FIG. 11 is a cross-sectional view illustrating a shape in which a multilayer ceramic capacitor according to the embodiment of FIG. 9 is mounted on a circuit board through soldering.

FIG. 12 is a perspective view illustrating a third embodiment of the present disclosure.

FIG. 13 is a cross-sectional view illustrating a shape in which a multilayer ceramic capacitor according to the embodiment of FIG. 12 is mounted on a circuit board through soldering.

FIG. 14 is a flowchart explaining a process of mounting a multilayer ceramic capacitor on a circuit board through soldering.

FIG. 15 is a flowchart explaining a method for manufacturing a multilayer ceramic capacitor.

FIG. 16 is an exploded perspective view explaining a process of manufacturing the present disclosure.

FIG. 17 is an exploded perspective view of another embodiment of FIG. 16.

FIG. 18 is an exploded perspective view of a ceramic body of the present disclosure.

### DESCRIPTION OF EMBODIMENTS

The aspects and features of the present disclosure and methods for achieving the aspects and features will be apparent by referring to the embodiments to be described in detail with reference to the accompanying drawings. However, the present disclosure is not limited to the embodiments disclosed hereinafter, and it can be implemented in various different forms. However, the embodiments are provided to complete the present disclosure and to assist those of ordinary skill in the art in a comprehensive understanding of the scope of the technical idea, and the disclosure is only defined by the scope of the appended claims.

Terms used in the description are to explain specific embodiments, but are not intended to limit the present disclosure. Further, in the description, unless specially described on the contrary in context, a singular form may include a plural form.

In the description, the term “comprises” and/or “comprising” should be interpreted as not excluding the presence or addition of one or more other constituent elements in addition to the mentioned constituent elements.

The term “and/or” used in the description includes each of the mentioned constituent elements and all combinations of one or more thereof. Although the terms “first”, “second”, and so forth are used to describe various constituent elements, these constituent elements should not be limited by the terms. The above-described terms are used only for the purpose of discriminating one constituent element from another constituent element. Accordingly, a first constituent element to be mentioned hereinafter may be a second constituent element in the technical idea of the present disclosure.

The term “horizontal direction” used in the following description means a forward, rearward, left, or right direction in a state where a location in an upward or downward direction is not changed, and the term “vertical direction” used in the following description means an upward or downward direction in a state where a location in a forward, rearward, left, or right direction is not changed.

The drawings are merely to understand the idea of the present disclosure, and it should not be interpreted that the scope of the present disclosure is limited by the drawings. Further, in the drawings, relative thicknesses, lengths, or sizes may be exaggerated for convenience and clarity of the description, and throughout the description, the same reference numerals refer to the same constituent elements.

Hereinafter, embodiments of the present disclosure will be described in detail with reference to the accompanying drawings.

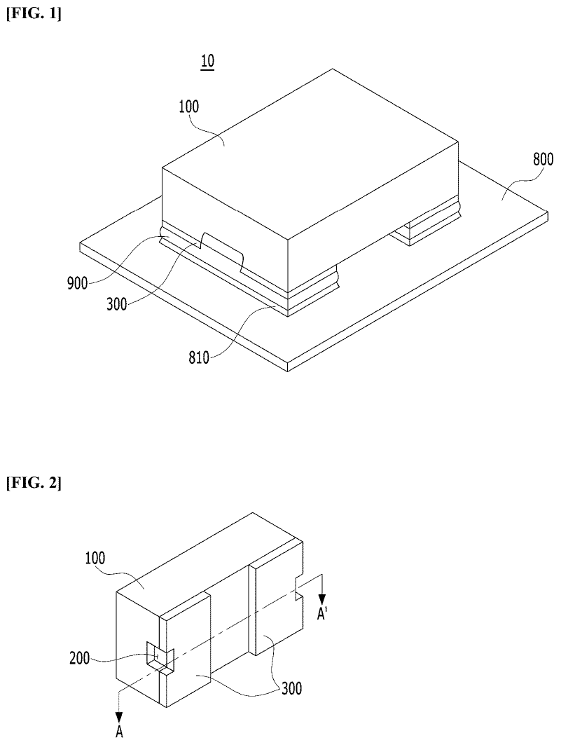

FIG. 1 is a perspective view illustrating a state where a multilayer ceramic capacitor 10 according to an embodiment of the present disclosure is mounted on a circuit board through soldering.

Referring to FIG. 1, a multilayer ceramic capacitor 10 according to an embodiment of the present disclosure includes a ceramic body 100 and a lower electrode 300.

The ceramic body 100 is constituted by laminating a plurality of dielectric layers. The dielectric layer includes a material capable of obtaining capacitance. For example, the dielectric material may include a ceramic powder, ceramic additives, and the like. The dielectric layer may also be composed of a ceramic green sheet, and the thickness of the dielectric layer may be arbitrarily changed to fit to capacity design according to an embodiment of the present disclosure.

There are no particular restrictions on the shape of the ceramic body 100, but, as illustrated, the ceramic body 100 may be formed in a hexahedron shape. Although corners of the ceramic body 100 are not perfectly straight due to high temperature and the like in a manufacturing process, the ceramic body 100 may have substantially the hexahedron shape.

The lower electrode 300 is formed on a lower surface of the ceramic body 100. There are no particular restrictions on the material that forms the lower electrode 300, and the lower electrode 300 may be formed by using a conductive material including, for example, silver, copper, lead, platinum, and nickel. Further, the lower electrode 300 may be formed on both side surfaces of the lower surface of the ceramic body 100.

Further, although not illustrated, the lower electrode 300 may be formed in a three-layer structure of copper, silver-epoxy, and nickel. Tin may be used instead of nickel. In this case, the silver-epoxy may absorb an external force that is applied to the lower electrode 300, and may prevent cracks from occurring on the ceramic body 100.

If a voltage is applied to the lower electrode 300, electric charge is accumulated on an inner electrode 400 to be described later.

The lower electrode 300 may be seated on a circuit pattern 810 of a circuit board 800, and may be joined to a solder 900. A process of joining the lower electrode 300 to the circuit pattern 810 is called soldering.

Although not illustrated, the solder 900 may rise up an outer side surface of the lower electrode 300 in a soldering process, or may partially cover an outer side surface of the ceramic body 100.

The solder 900 may be made of a material having prominent mechanical properties and electrical conductivity. For example, the solder 900 may be made of a tin-lead alloy and the like.

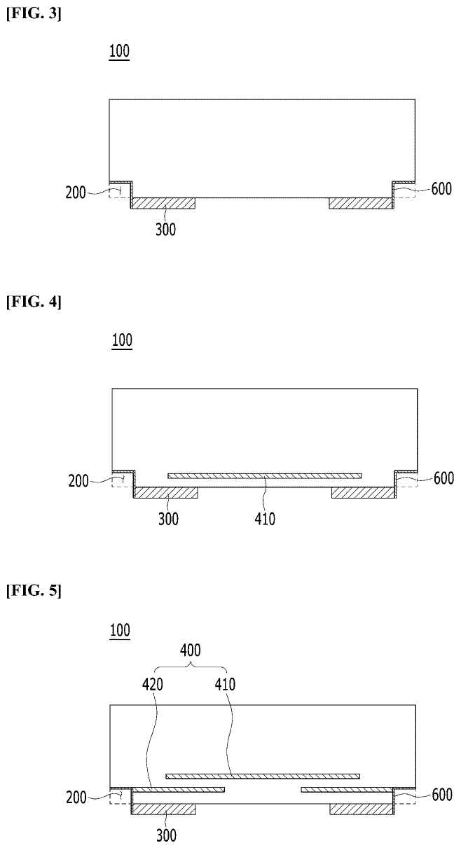

FIG. 2 is a perspective view illustrating a first embodiment of the present disclosure, and FIG. 3 is a cross-section view taken along line A-A′ of FIG. 2.

Referring to FIGS. 2 and 3, the multilayer ceramic capacitor 10 according to the present disclosure further includes a recessed part 200.

The recessed part 200 is formed to be depressed at a corner where a side surface and a lower surface of the ceramic body 100 come in contact with each other.

In the illustrated embodiment, the recessed part 200 may be formed to be depressed so that the lower surface and one side surface thereof are open. The depressed shape may be a cuboidal shape, but is not necessarily limited thereto.

In case of soldering the lower electrode 300 of the ceramic body 100 on the circuit board of FIG. 1, the solder may flow into the recessed part 200.

In case that the recessed part 200 is provided on the ceramic body 100, the surface area of the side surface of the ceramic body 100 is increased, and thus in case of soldering the lower electrode 300 on the circuit board 800, the amount of solder 900 that can contact the ceramic body 100 is increased. The detailed explanation of the recessed part 200 for this will be made later.

The recessed part 200 includes a metal layer 600 that is formed on the surface of the recessed part 200. The metal layer 600 may be formed to extend up to the lower electrode 300.

In case that the lower electrode 300 is mounted on the circuit board 800 by soldering, the solder 900 may rise along the metal layer 600, and may facilitate its joining to the recessed part 200.

The metal layer 600 may be made of one of gold, silver, and copper, or a mixed metal thereof. However, the material of the metal layer 600 is not necessarily limited to the mentioned material.

The lower electrode 300 may be formed by printing or applying a lower electrode material on the lower surface of the ceramic body 100 produced with a dielectric material.

In this case, the lower electrode 300 may be formed with one side thereof cut as illustrated so that the lower surface of the recessed part 200 is open.

Specifically, the shape of the cross section of the lower electrode 300 that corresponds to the cross section of the recessed part 200 may be formed by cutting an area that overlaps the lower surface of the recessed part 200 on the lower electrode 300.

FIG. 4 is a cross-sectional view illustrating an inner electrode 400 added to an embodiment of FIG. 2.

Referring to FIG. 4, the multilayer ceramic capacitor 10 according to an embodiment of the present disclosure includes an inner electrode 400.

The inner electrode 400 is disposed inside the ceramic body 100, and if a voltage is applied to the lower electrode 300, electric charge is accumulated on the inner electrode 400.

The inner electrode 400 is composed of a conductive material that can store and discharge the electric charge, and the material thereof is not specially restricted. For example, the material may be composed of silver, lead, platinum, copper, or a combination thereof, but is not limited to the enumerated examples.

The inner electrode 400 includes a first inner electrode 410.

The first inner electrode 410 is disposed inside the ceramic body so that both ends thereof overlap partial areas of the lower electrode 300. Further, the first inner electrode 410 may be disposed to be spaced apart from the side surface of the ceramic body 100. That is, the first inner electrode 410 is not exposed to an outside of the ceramic body 100.

In this case, the capacitance can be adjusted by adjusting the area where the both ends of the first inner electrode 410 and the lower electrode 300 overlap (face) each other. If the area where the first inner electrode 410 and the lower electrode 300 overlap each other is increased, a relatively large amount of electric charge can be accumulated.

Although not illustrated, a plurality of first inner electrodes 410 may be disposed to be stacked at predetermined intervals. In this case, between the plurality of first inner electrodes 410, a dielectric layer is disposed. Due to this, the capacitance can be additionally formed.

FIG. 5 is a cross-sectional view illustrating another embodiment of FIG. 4, and FIG. 6 is a cross-sectional view illustrating still another embodiment of FIG. 4.

Referring to FIGS. 5 and 6, the inner electrode 400 further includes second inner electrodes 420.

The second inner electrode 420 is disposed to be spaced apart from the first inner electrode 410, and is exposed through a part where the recessed part 200 is formed of the outer surface of the ceramic body 100. Accordingly, the second inner electrode 420 may be electrically connected to the metal layer 600 formed on the surface of the recessed part 200. Due to this, the second inner electrode 420 may also be electrically connected to the lower electrode 300 through the metal layer 600, and thus the electric charge may be directly charged by the lower electrode 300.

Meanwhile, the second inner electrodes 420 may be formed on both side surfaces of the ceramic body 100, and the second inner electrodes 420 exposed to the outside of the ceramic body 100 are formed toward the inside of the ceramic body 100.

Meanwhile, the second inner electrode 420 may be disposed between the first inner electrode 410 and the lower electrode 300. Accordingly, the second inner electrode 420 may add the capacitance on an area that overlaps the first inner electrode 410. Further, the second inner electrode 420 may add the capacitance on the area that overlaps the lower electrode 300.

Referring again to FIG. 6, one side of the second inner electrode 420 may come in contact with the surface of the recessed part 200, and may be exposed to the outside of the ceramic body 100 as well. In this case, since the metal layer 600 is provided on the surface of the recessed part 200, the second inner electrode 420 and the lower electrode 300 may be electrically connected to each other.

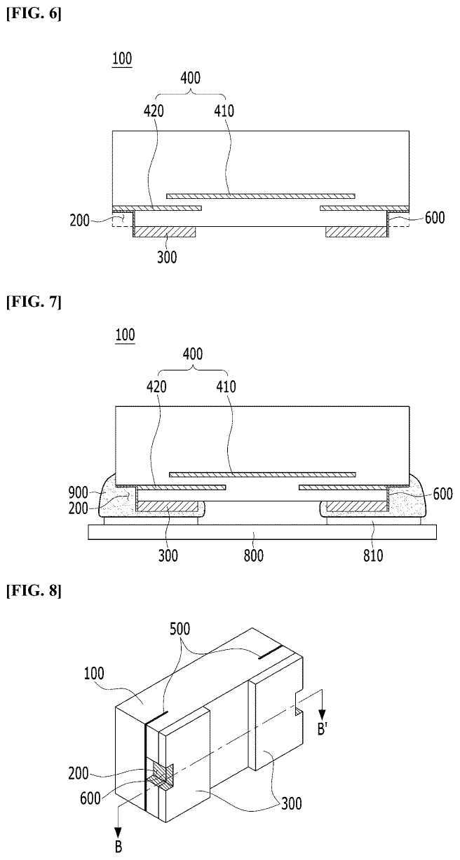

FIG. 7 is a cross-sectional view illustrating a shape in which the embodiment of FIG. 5 is mounted on a circuit board 800 through soldering.

Referring to FIG. 7, as for the metal layer 600, in the soldering process for mounting the lower electrode 300 on the circuit board 800, the solder 900 rises up the metal layer 600 of the recessed part 200, and thus the soldering can be performed more stably.

In particular, as described above, since the surface area of the side surface of the ceramic body 100 provided with the recessed part 200 like the illustrated embodiment is wider than that of the ceramic body 100 that is not provided with the recessed part 200, a larger amount of solder can rise up the side surface of the ceramic body 100. Due to this, the joining force between the ceramic body 100 and the circuit board 800 is increased, and thus the lower electrode 800 and the ceramic body 100 can be stably joined.

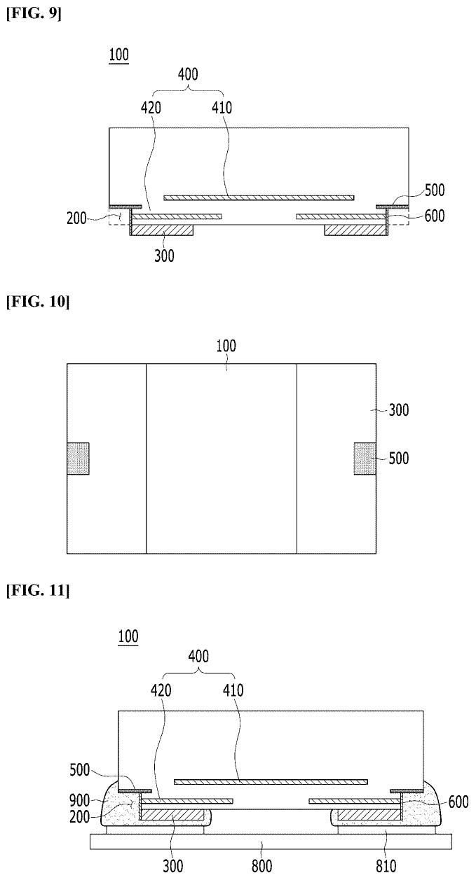

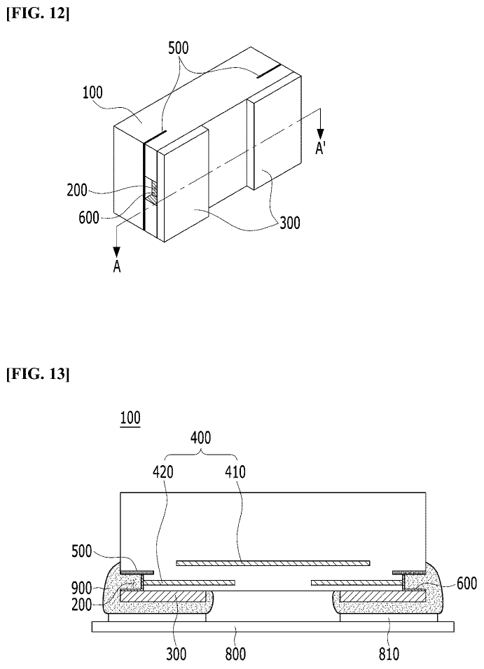

FIG. 8 is a perspective view illustrating a second embodiment of the present disclosure, FIG. 9 is a cross-sectional view taken along line B-B′ of FIG. 8, and FIG. 10 is a bottom view of FIG. 8.

Referring to FIGS. 8 to 10, the ceramic body 100 of the multilayer ceramic capacitor 10 according to the second embodiment of the present disclosure includes a dummy electrode 500.

The dummy electrode 500 is disposed inside the ceramic body 100, and is exposed to both side surfaces of the ceramic body 100.

The dummy electrode 500 is to secure the tensile strength of the multilayer ceramic capacitor 10. In case that the ceramic body 100 is made of only the dielectric or only the inner electrode 400 without being provided with the dummy electrode 500, the tensile strength may be low due to the characteristics of the ceramic material.

In particular, in case of soldering the lower electrode 300 on the circuit board 800 in a state where the ceramic body 100 is made of only the dielectric, the load is concentrated as the solder is joined to both sides of the ceramic body 100, and thus cracks may occur on the ceramic body 100. Accordingly, as described above, in case of the soldering with the dummy electrode 500 provided, the cracks can be prevented from occurring on the ceramic body 100.

FIG. 11 is a cross-sectional view illustrating a shape in which a multilayer ceramic capacitor 10 according to the embodiment of FIG. 9 is mounted on a circuit board 800 through soldering.

Referring to FIG. 11, the dummy electrode 500 may be exposed through the side surface of the ceramic body 100, and may also be exposed through the recessed part 200 as well. In case of soldering the lower electrode 300 on the board in a state where the dummy electrode 500 is exposed, the solder rises up from the side surface of the ceramic body up to the dummy electrode, and thus the soldering height may be increased. Accordingly, the lower electrode 300 can be stably joined to the circuit pattern 810, and the connection reliability can also be increased through widening of the area of the lower electrode 300 that is connected to the circuit board 800.

Further, since the metal layer 600 that connects the part of the dummy electrode 500 and the lower electrode 300 to each other is provided in the ceramic body 100 that is finally manufactured through cutting and sintering as described above, the solder 900 rises up the metal layer 600 during soldering, and thus the soldering can be performed more stably.

FIG. 12 is a perspective view illustrating a third embodiment of the present disclosure, and FIG. 13 is a cross-sectional view illustrating a shape in which a multilayer ceramic capacitor 10 according to the embodiment of FIG. 12 is mounted on a circuit board 800 through soldering.

Referring to FIGS. 12 and 13, in case of the illustrated third embodiment, unlike other embodiments as described above, the recessed part 200 is formed to be depressed in a cuboidal shape with only one side surface of the recessed part 200 open.

That is, in the above-described embodiment, one side of the lower electrode 300 can formed to be cut so that not only one side surface but also the lower surface of the recessed part 200 is open, whereas in case of the illustrated third embodiment, the lower electrode 300 can be formed on the lower surface of the ceramic body 100 in a state where the cuboidal shape is maintained.

In this case, as illustrated in FIG. 13, the cross section of the recessed part 200 can be formed in a “E” shape. As compared with the case that the cross section of the recessed part 200 earlier illustrated in FIG. 7 or 11 is in a “7” shape, it can be known that a larger surface area of the recessed part 200 illustrated in FIG. 13 is formed.

Accordingly, in case of soldering the lower electrode 300 on the circuit board 800, a larger amount of solder 900 can be accommodated in the recessed part 200, and the joining force between the lower electrode 300 and the circuit board 800 can be further improved.

Meanwhile, although not illustrated, the recessed part 200 may be provided with a continuous curved surface that is formed to be depressed.

In case that a depression forming space of the recessed part 200 is formed in the shape of a hexahedron having corners, cracks may occur on the ceramic body 100 around the corners where included angles are formed in the process of soldering the lower electrode 300 on the circuit board 800. However, in case that the wall surface of the depression forming space is composed of the continuous curved surface, the stress can be dispersed, and thus the cracks can be prevented from occurring.

FIG. 14 is a flowchart explaining a process of mounting a multilayer ceramic capacitor 10 on a circuit board through soldering.

Referring to FIG. 14, a process of mounting a multilayer ceramic capacitor according to the present disclosure on a circuit board includes: a step (S100) of manufacturing a ceramic body 100; a step (S200) of seating a lower electrode 300 of the ceramic body 100 on a circuit pattern 810 of the circuit board 800 and performing soldering with a solder 900; and forming an electrode as the solder 900 rises up a recessed part 200.

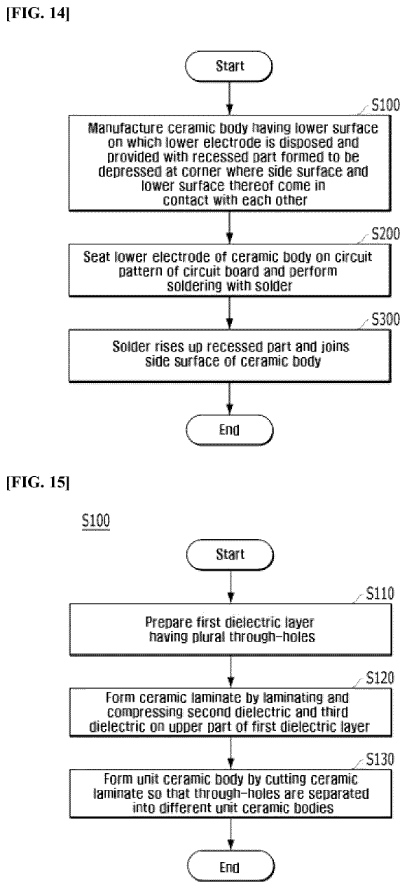

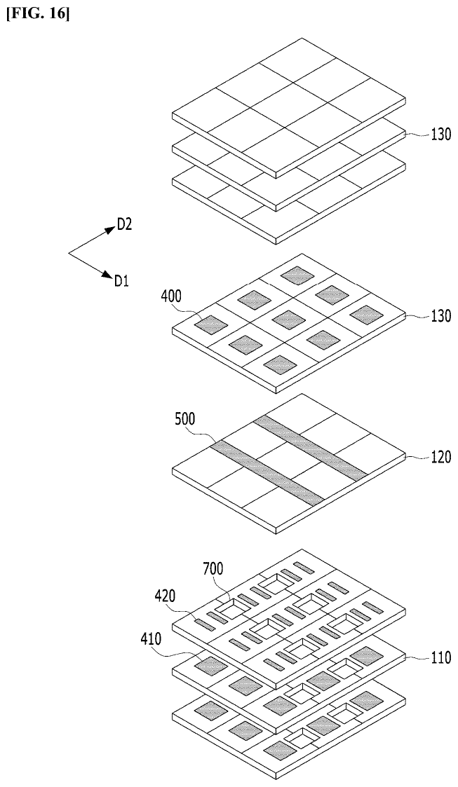

The step (S100) of manufacturing the ceramic body 100 will be described in detail with reference to FIG. 15. Further, since the steps (S200 and S300) are substantially the same as those of the embodiments of the multilayer ceramic capacitor as described above, the explanation thereof will be omitted.

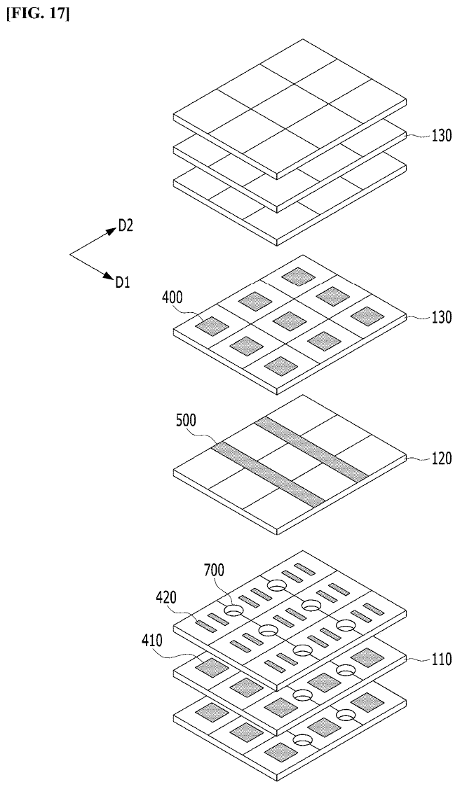

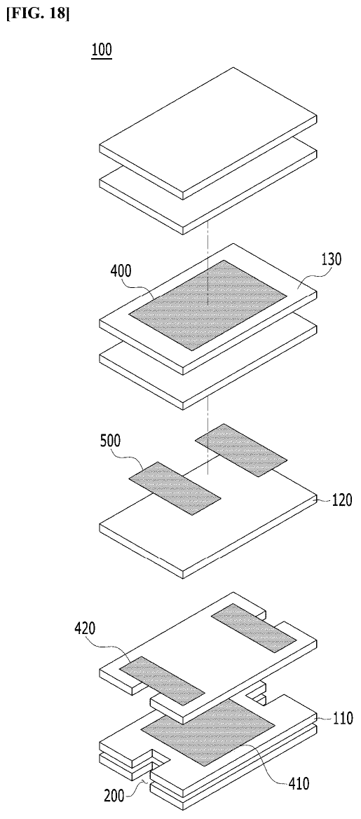

FIG. 15 is a flowchart explaining a method for manufacturing a multilayer ceramic capacitor, FIG. 16 is an exploded perspective view explaining a process of manufacturing the present disclosure, FIG. 17 is an exploded perspective view of another embodiment of FIG. 16, and FIG. 18 is an exploded perspective view of a ceramic body of the present disclosure.

Referring to FIGS. 15 to 18, a method for manufacturing a multilayer ceramic capacitor 10 according to the present disclosure includes: a step (S110) of preparing a first dielectric layer having a plurality of through-holes 700; a step (S120) of forming a ceramic laminate by laminating a second dielectric layer 120 and a third dielectric layer 130 on an upper part of the first dielectric layer 110; and a step (S130) of forming a plurality of unit ceramic bodies 100 by cutting the ceramic laminate so that the through-holes 700 are separated into different unit ceramic bodies.

In the step (S110) of preparing the first dielectric layer 100, the dielectric material that forms the first dielectric layer may be barium (BaTiO3)-based ceramic having a high permittivity. In addition, the dielectric material that forms the first dielectric layer 110 may use or additionally include (Ca, Zr)(Sr, Ti)O3-based ceramic. However, since the capacitance is in proportion to the permittivity of the dielectric, it is preferable to use the dielectric material BaTiO3 having the high permittivity. A ceramic laminate may be constituted through laminating of the plurality of first dielectric layers 110.

In the step (S110) of preparing the first dielectric layer 110, a plurality of through-holes 700 are formed on the first dielectric layer 110. The through-hole 700 is a constituent element for forming the recessed part 200 on the unit ceramic body 100, and the detailed explanation thereof will be made later.

The through-hole 700 may be arranged on the first dielectric layer 110 in a lattice format.

The through-hole 700 may be formed by radiating a laser onto the first dielectric layer 110. In this case, the shape of the cross section of the through-hole 700 may be rectangular as illustrated in FIG. 16. However, the shape of the through-hole 700 is not limited thereto, and as illustrated in FIG. 17, the shape of the through-hole 700 may be circular.

In the step (S120) of forming the ceramic laminate, the second dielectric layer 120 and the third dielectric layer 130 are laminated on the upper part of the first dielectric layer 110 and then compressed by applying heat thereto. In this case, the ceramic laminate can be formed by compressing, cutting, and sintering the laminated ceramic sheets.

In the step (S120) of forming the ceramic laminate, the dielectric layer 120 may be provided with the dummy electrode 500.

The dummy electrode 500 may have a rectangular shape, in which the length in a first direction D1 is long, and the length in a second direction D2 is short, and a plurality of dummy electrodes 500 may be formed at predetermined intervals along the second direction D2.

As described above, the role of the dummy electrode 500 is to secure the tensile strength of the multilayer ceramic capacitor 10. In case that the ceramic body 100 is made of only the dielectric or only the inner electrode 400 without being provided with the dummy electrode 500, the tensile strength may be low due to the characteristics of the ceramic material.

Further, in the step (S120) of forming the ceramic laminate, the third dielectric layer 130 may be provided with the inner electrode 400. A plurality of inner electrodes 400 may be formed by laminating at predetermined intervals in order to form the capacitance desired by a user, and may also be provided on the first dielectric layer 110 or the second dielectric layer 120.

Meanwhile, as illustrated in FIGS. 16 and 17, by cutting the ceramic laminate formed through the step (S120) of forming the ceramic laminate along a plurality of first virtual lines formed in the first direction D1 and a plurality of second virtual lines formed in the second direction D2, a plurality of ceramic bodies 100 can be formed (S130). That is, the ceramic laminate formed in the step (S120) is cut so that the through-holes 700 are separated into different unit ceramic bodies 100.

Accordingly, the through-holes 700 are separated into the different ceramic bodies 100, and thus the recessed part 200 is formed on the respective unit ceramic bodies 100. Specifically, the recessed part 200 is formed at the corner where the both side surfaces and the lower surface of the ceramic body 100 face each other as the through-holes 700 are cut in the height direction (length direction).

In the illustrated embodiment, after the first dielectric layer 110 is laminated, the through-holes 700 are formed before the second dielectric layer 120 is laminated. Thereafter, since the second dielectric layer 120 and the third dielectric layer 130 are laminated on the upper part of the first dielectric layer 110, the recessed part is not formed near the upper surface of the generated ceramic body 100, but the recessed part 200 is formed to be depressed only at the corner where the lower surface and the both side surfaces face each other.

If the ceramic body 100 is formed through cutting and sintering after forming the through-holes 700 that penetrate all of the dielectric layers after forming the ceramic laminate through laminating of all of the first dielectric layer, the second dielectric layer, and the third dielectric layer, there may be an increased likelihood of cracks occurring on the ceramic body 100 in the following process of soldering the ceramic body 100 on the circuit board 800. Accordingly, the cracks can be prevented from occurring in case that the ceramic body 100 is manufactured by forming the through-holes 700 after laminating the first dielectric layer 110 and by laminating the second dielectric layer 120 and the third dielectric layer 130.

The step of forming the ceramic body 100 includes a step of forming the lower electrode 300 on both sides of the lower surface of the ceramic body 100.

As an example, the multilayer ceramic capacitor 10 may also be manufactured by forming the lower electrode 300 on both sides of the lower surface of the ceramic sheet manufactured with the dielectric material, repeatedly laminating the ceramic sheets produced with only the dielectric material on the upper surface of the lower electrode 300, and then cutting and sintering the laminated ceramic sheets in the form of a chip after increasing the density through compression.

As another example to form the multilayer ceramic capacitor 10, after the repeatedly laminated ceramic sheets are sintered and cut, the material of the lower electrode 300 may be printed or applied onto both sides of the lower surface of the ceramic body 100.

In this case, the ceramic sheet may be manufactured through a molding process in which slurry is made by evenly mixing a dielectric material powder and added ingredients, and then the slurry is evenly coated on a film.

Meanwhile, the step of forming the through-hole 700 includes a step of forming the metal layer 600 in the through-hole 700. The metal layer 600 may be formed by plating nickel and tin on the through-hole 700. Since the effects produced by the metal layer 600 in the multilayer ceramic capacitor 10 are the same as those as described above, the detailed explanation thereof will be omitted. In addition, in case that the metal layer 600 is additionally formed, the moisture resistance may be improved.

Meanwhile, in case that the second dielectric layer 120 of the ceramic body 100 formed in the step (S130) is provided with the dummy electrode 500, the dummy electrode 500 may be exposed to both side surfaces of the ceramic body 100. Accordingly, in case of soldering the lower electrode 300 on the circuit board 800, the solder may rise up to the height at which the dummy electrode 500 is exposed along the both side surfaces of the ceramic body 100.

The above explanation of the present disclosure is merely for exemplary explanation of the technical idea of the present disclosure, and it can be understood by those of ordinary skill in the art to which the present disclosure pertains that various corrections and modifications thereof will be possible in a range that does not deviate from the essential characteristics of the present disclosure. Accordingly, it should be understood that the embodiments disclosed in the present disclosure are not to limit the technical idea of the present disclosure, but to explain the same, and thus the scope of the technical idea of the present disclosure is not limited by such embodiments. The scope of the present disclosure should be interpreted by the appended claims to be described later, and all technical ideas in the equivalent range should be interpreted as being included in the scope of the present disclosure.

1. A multilayer ceramic capacitor comprising:
a ceramic body in which a plurality of dielectric layers are laminated;
a recessed part formed to be depressed at a corner where a side surface of the ceramic body and a lower surface of the ceramic body come in contact with each other; and
a lower electrode formed on the lower surface of the ceramic body.

2. The multilayer ceramic capacitor of claim 1, wherein the recessed part is formed to be depressed so that one side surface thereof is open.

3. The multilayer ceramic capacitor of claim 1, wherein the recessed part is formed to be depressed so that a lower surface and one side surface thereof are open.

4. The multilayer ceramic capacitor of claim 1, wherein the recessed part is provided with a continuous curved surface that is formed to be depressed.

5. The multilayer ceramic capacitor of claim 3, wherein the lower electrode is formed in a shape that opens the lower surface of the recessed part.

6. The multilayer ceramic capacitor of claim 5, wherein the lower electrode is formed to be depressed at a location that corresponds to the lower surface of the recessed part.

7. The multilayer ceramic capacitor of claim 1, wherein the ceramic body comprises an inner electrode disposed inside the ceramic body, and
wherein the inner electrode includes a first inner electrode spaced apart from the side surface of the ceramic body and having both ends that overlap the lower electrode.

8. The multilayer ceramic capacitor of claim 7, wherein the inner electrode comprises a second inner electrode disposed to be spaced apart from the first inner electrode and exposed to the recessed part.

9. The multilayer ceramic capacitor of claim 1, wherein the ceramic body comprises a dummy electrode disposed inside the ceramic body and exposed to both side surfaces of the ceramic body.

10. The multilayer ceramic capacitor of claim 9, wherein the dummy electrode is disposed inside the ceramic body and exposed through an upper surface of the recessed part.

11. The multilayer ceramic capacitor of claim 1, wherein the recessed part comprises a metal layer formed on a surface of the recessed part and electrically connected to the lower electrode.

12. A method for manufacturing a multilayer ceramic capacitor comprising:
a step of preparing a first dielectric layer having a plurality of through-holes;
a step of forming a ceramic laminate by laminating a second dielectric layer and a third dielectric layer on an upper part of the first dielectric layer; and
a cutting step of forming a plurality of unit ceramic bodies by cutting the ceramic laminate so that the through-hole is separated into different unit ceramic bodies.

13. The method of claim 12, wherein in the cutting step, the through-hole is separated into the different ceramic bodies, and a recessed part is formed on each of the unit ceramic bodies.

14. The method of claim 12, wherein in the step of forming the ceramic laminate, the second dielectric layer is provided with a dummy electrode.

15. The method of claim 12, wherein in the step of forming the ceramic laminate, the third dielectric layer is provided with an inner electrode.

16. The method of claim 12, wherein the step of forming the ceramic laminate comprises a step of forming a metal layer on the through-hole.

17. The method of claim 12, wherein in the step of forming the through-hole, a cross section of the through-hole is circular.

18. The method of claim 12, wherein the step of forming the plurality of unit ceramic bodies comprises a step of forming a lower electrode on both sides of a lower surface of each of the unit ceramic bodies.
